(19) United States
(12) Patent Application Publication
(10) Pub. No.: US 2017/0147023 A1
(43) Pub. Date: May 25, 2017

(54) TIME-SKEW CORRECTION UNIT AND A METHOD THEREOF

(71) Applicant: HITACHI, LTD., Tokyo (JP)

(72) Inventors: N. Vinoth KUMAR, Bangalore (IN); Yasushi HARADA, Bangalore (IN)

(73) Assignee: HITACHI, LTD., Tokyo (JP)

(21) Appl. No.: 15/359,156

(22) Filed: Nov. 22, 2016

(30) Foreign Application Priority Data
Nov. 24, 2015 (IN) 6323/CHE/2015

(51) Int. Cl. G05F 1/66; G05B 15/02

(52) U.S. Cl. CPC G05F 1/66; G05B 15/02; G05B 2219/40458

(57) ABSTRACT

Embodiments of the present disclosure relate to a time-skew correction unit and a method thereof. The time-skew correction unit classifies the electric grid into plurality of regions with one or more generators in said plurality of regions and obtains response time of one or more generators corresponding to each of the plurality of regions from a simulator. The time-skew correction unit further monitors the plurality of regions in real-time for predefined value of change of load data from one or more loads in the electric grid and determines time-skew offset for each of the plurality of regions based on the response time of the one or more generator and corresponding real-time data from the plurality of regions. Further, time-stamp of the real-time data from each of the plurality of regions is adjusted based on the time skew offset of corresponding plurality of regions for time-skew correction in the electric grid.

### TECHNICAL FIELD

The present subject matter generally relates to time-skew correction. More particularly, but not exclusively, the present disclosure discloses a time-skew correction unit and a method for time-skew correction in an electric grid.

### BACKGROUND

An electric grid is a network of electrical components used for supplying power to regions such as residence and industries. Electricity is generated, transmitted, distributed across the electric grid through control networks associated with the electric grid. State estimation of the electric grid includes obtaining data or measurements across the electric grid which include topology, analog parameters (power, voltage etc.) and observability (error in data) in the electric grid.

FIG. 1 illustrates a conventional system implemented in an electric grid for state estimation without a time-skew correction unit.

In the conventional system, a state estimator 105 along with a Supervisory Control And Data Acquisition unit (SCADA) 101, an analyser 102, a topology processor 103 and a bad data detector 104 is implemented in a control unit of the electric grid for detecting state of the electric grid. Data from the SCADA 101 at a particular instant of time is used to obtain topology by the topology processor 103 and to perform analog observations and error detection by the analyser 102. The analog observations include observations in power, voltage, current etc. in the SCADA data. Since no time-skew correction is performed, time-skewed data may be detected as bad-data by the bad data detector 104 and therefore discarded. The state may not be accurate when the data is obtained simultaneously from sensors in the electric grid using SCADA.

Some of existing systems disclose a solution for problems relating to state-estimation due to poor data and delays in communication.

One of existing systems discloses a modelling method for time delay characteristic measuring system in a widest area. The method involves calculating time delay in the system and pre-processing the time delay. The method further involves pre-processing of frequency calculated of the time delay. Further, the system deals with removing wrong data.

One of existing systems discloses a power system multi-zone distribution state estimation method based on synchronous phase angle measurement device. The method adopts a geographical characteristic-based non-overlapping decoupling strategy to decouple a large power system into subsystems. The states of the subsystems are integrated by a coordination system. Further with adoption of the multi-zone distributed state estimation method, estimation of states of large system turns into estimation of states of a series of partial small zones, so that computation speed is greatly improved. Real-time accurate measurement information of voltage, phase angle and etc. can be offered to the system, and the system is enabled to obtain higher measurement redundancy. Also, Distributed bad data processing is conducted.

In some embodiments, the data obtained may not be Global Positioning System (GPS) time-stamped and there exist varied latencies and time-skews relating to distance of the sensors from control unit. In some embodiments, the latencies and time-skews may be due to low communication system performance. Due to the latencies and the time-skews, during the state estimation of the electric grid, the obtained data may be considered as bad data and is discarded. Therefore, latency and time-skew affect the state estimation of the electric grid and thereby affects efficient operation and controlling of the grid in desired manner during fault scenarios.

In view of above, the existing technologies and the conventional systems for estimation of state of an electric grid do not consider parameters such as time-skew and latency for the state estimation and some systems implement a complex system to obtain accurate state of the electric grid. Hence, there is a need for a system and method for correction of time-skew in an electric grid with lesser complexity and to avoid discarding time-skewed as bad data for obtaining accurate state of the electric grid.

### SUMMARY

Disclosed herein is a method for time-skew correction in an electric grid is disclosed in the present disclosure. The method involves classifying the electric grid into a plurality of regions with one or more generators in the said plurality of regions. Further, the method involves obtaining response time of the one or more generators corresponding to each of the plurality of regions from a simulator and monitoring the plurality of regions in real-time for a predefined value of change of load data from one or more loads in the electric grid. Further time-skew offset is determined for each of the plurality of regions based on the response time of the one or more generator and corresponding real-time data from the plurality of regions is performed where the response time is associated with the predefined value of change of the load data. Further, time-stamp of the real-time data received from each of the plurality of regions is adjusted which is based on the time skew offset of corresponding plurality of regions for the time-skew correction in the electric grid.

In an embodiment, the present disclosure discloses a time-skew correction unit in an electric grid which comprises a processor and a memory communicatively coupled to the processor. The memory stores processor-executable instructions which on execution cause the processor to classify the electric grid into a plurality of regions based on one or more generators in the said plurality of regions. Further the processor obtains response time of the one or more generators corresponding to each of the plurality of regions from a simulator and monitor the plurality of regions in real-time for a predefined value of change of load data from one or more loads in the electric grid. Further, the processor determines time-skew offset for each of the plurality of regions based on the response time of the one or more generator and corresponding real-time data from the plurality of regions where the response time is associated with the predefined value of change of the load data. Further the processor adjusts time-stamp of the real-time data received from each of the plurality of regions, based on the time skew offset of corresponding plurality of regions for the time-skew correction in the electric grid.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a conventional system implemented in an electric grid for state estimation without a time-skew correction unit;

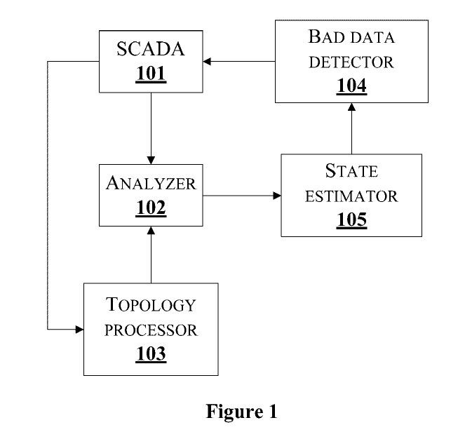

FIG. 2 illustrates a system implemented in an electric grid for state estimation with a time-skew correction unit in accordance with one embodiment of the present disclosure;

FIG. 3 illustrates an exemplary embodiment of an electric grid implementing a time-skew correction unit in accordance with one embodiment of the present disclosure;

FIG. 4 illustrates a detailed block diagram of an exemplary time-skew correction unit with various data and modules for time-skew correction in an electric grid in accordance with some embodiments of the present disclosure;

FIG. 5 illustrates a flow diagram showing steps performed by a time-skew correction unit in accordance with some embodiments of the present disclosure;

FIG. 6a illustrates an exemplary embodiment of an electric grid representing plurality of regions in accordance with some embodiments of the present disclosure;

FIG. 6b illustrates a plot representing output data from one or more generators and associated one or more loads with respect to time-stamp of real-time data in accordance with some embodiments of the present disclosure;

FIG. 6c illustrates adjusting of time-stamp of real-time data in accordance with some embodiments of the present disclosure; and

FIG. 7 illustrates a block diagram of an exemplary computer system for implementing some embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a time-skew correction unit and a method for time-skew correction in an electric grid. Initially, the time-skew correction unit classifies the electric grid into a plurality of regions with one or more generators in the said plurality of regions. Further, time-skew correction unit obtains response time of the one or more generators corresponding to each of the plurality of regions from a simulator. The simulator performs simulation on modelled electric grid with the one or more generators and the one or more loads to obtain the response time. The response time is determined by the change in the output data with respect to the change in the load data during simulation. The load data is changed for plurality of predefined values to observe corresponding change in output data from each of the one or more generators. The load data and the output data are time stamped. Further, the time-skew correction unit monitors the plurality of regions in real-time for a predefined value of change of load data from one or more loads in the electric grid. Further, time-skew correction unit determines time-skew offset for each of the plurality of regions based on the response time of the one or more generator and corresponding real-time data from the plurality of regions. The response time of the one or more generators is associated with the predefined value of change of the load data. The predefined value is selected from the plurality of predefined values such that number of the one or more generators which provide output data for the predefined value of change of the load data is greater than number of the one or more generators which provide output data for other plurality of predefined values of change of the load data. Further upon determining the time-skew offset, time-skew correction unit adjusts time-stamp of the real-time data received from each of the plurality of regions based on the time-skew offset of corresponding plurality of regions for the time-skew correction in the electric grid.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

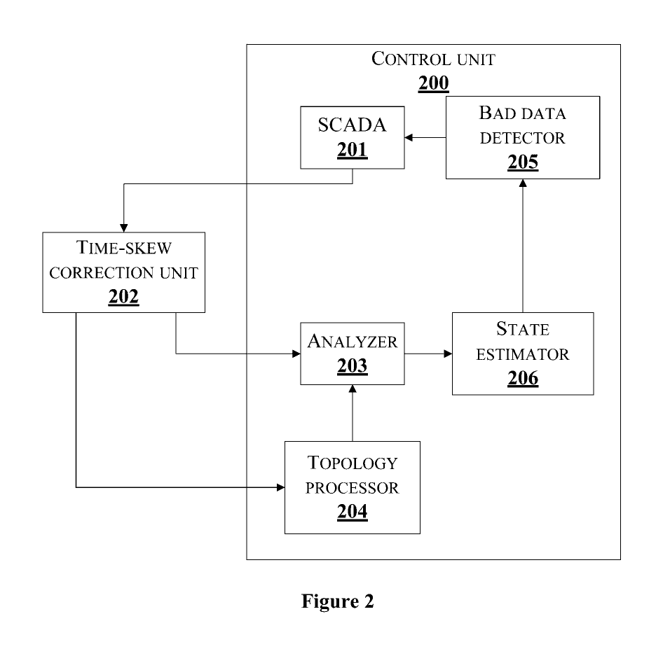

FIG. 2 illustrates a system implemented in an electric grid for state estimation with a time-skew correction unit in accordance with one embodiment of the present disclosure.

In the system for state estimation in an electric gird, a state estimator 206 along with a SCADA 201, an analyser 203, a topology processor 204 and a bad data detector 205 is implemented in a control unit 200 of the electric grid for detecting state of the electric grid. Additionally, a time-skew correction unit 202 is connected to the control unit 200 in the electric grid for time-skew correction before the state estimation is performed. The time-skew correction is performed by classifying the electric grid into a plurality of regions with one or more generators in the said plurality of regions. Further, the time-skew correction involves obtaining response time of the one or more generators corresponding to each of the plurality of regions from a simulator and monitoring the plurality of regions in real-time for a predefined value of change of load data from one or more loads in the electric grid. Further, time-skew offset is determined for each of the plurality of regions based on the response time of the one or more generator and corresponding real-time data from the plurality of regions. The response time of the one or more generators is associated with the predefined value of change of the load data. Further, time-stamp of the real-time data received from each of the plurality of regions through SCADA 201 is adjusted based on the time skew offset of corresponding plurality of regions for obtaining time-skew corrected data in the electric grid.

Time-skew corrected data from the time-skew correction unit 202 is obtains topology by the topology processor 204 and to perform analog observations and error detection by the analyser 203. The analog observations include observations in power, voltage, current etc. in the time-skew corrected data. Since the time-skew in SCADA data is corrected, data with time-skew is not considered as bad data by the bad data detector 205 and the state estimator 206 will estimate an accurate state of the electric grid.

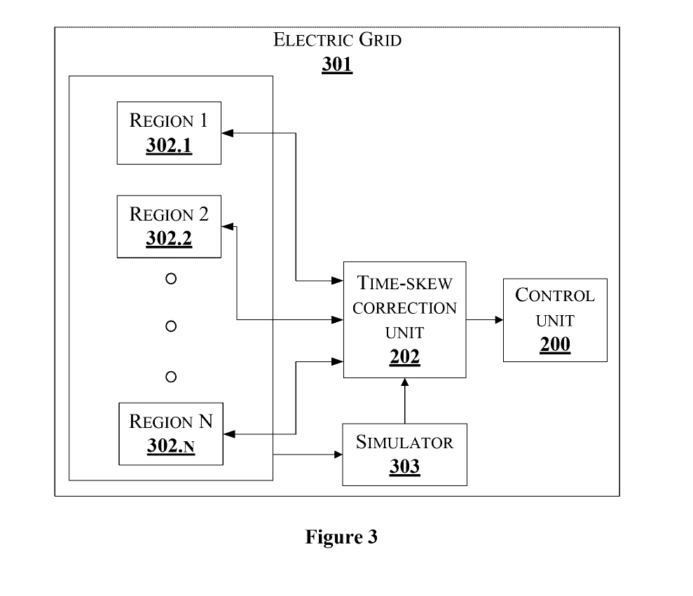

FIG. 3 illustrates an exemplary embodiment of an electric grid implementing a time-skew correction unit in accordance with one embodiment of the present disclosure.

The electric grid 301 comprises of electrical components such as generators, loads, sensors and so on for generation, transmission, distribution of electricity with control networks. State estimation of the electric grid 301 includes obtaining real-time data across the electric grid 301 which include but not limited to topology, analog parameters (power, voltage etc.) and observability (error in data) in the electric grid 301. The data is time-skew corrected before computing the state estimation. The electric grid 301 implements the time-skew correction unit 202 along with a simulator 303 and the control unit 200 for time-skew correction. Initially, the time-skew correction unit 202 classifies the electric grid 301 into a plurality of regions 302.1 . . . 302.n (collectively referred as 302) with one or more generators (not shown in figure) in the each of the said plurality of regions 302. In one embodiment, the plurality of regions 302 is classified by the time-skew correction unit based on the control unit 200. In one embodiment, the control unit 200 may be located approximately at center of the electric grid 301. Further, time-skew correction unit 202 obtains response time of the one or more generators corresponding to each of the plurality of regions 302 from a simulator 303. Further, the time-skew correction unit 202 monitors the plurality of regions 302 in real-time for a predefined value of change of load data from one or more loads in the electric grid 301. In one embodiment, the time-skew correction unit 202 monitors for the predefined value of change of load data at transient state of the electric grid 301. Further, time-skew correction unit 202 determines time-skew offset for each of the plurality of regions based on the response time of the one or more generator and corresponding real-time data from the plurality of regions 302. The response time of the one or more generators is associated with the predefined value of change of the load data. Further upon determining the time-skew offset, time-skew correction unit 202 adjusts time-stamp of the real-time data received from each of the plurality of regions 302 based on the time skew offset of corresponding plurality of regions 302 for the time-skew correction in the electric grid 301. Further, the state of the electric grid 301 is estimated using time-skew corrected data obtained upon performed time-skew correction.

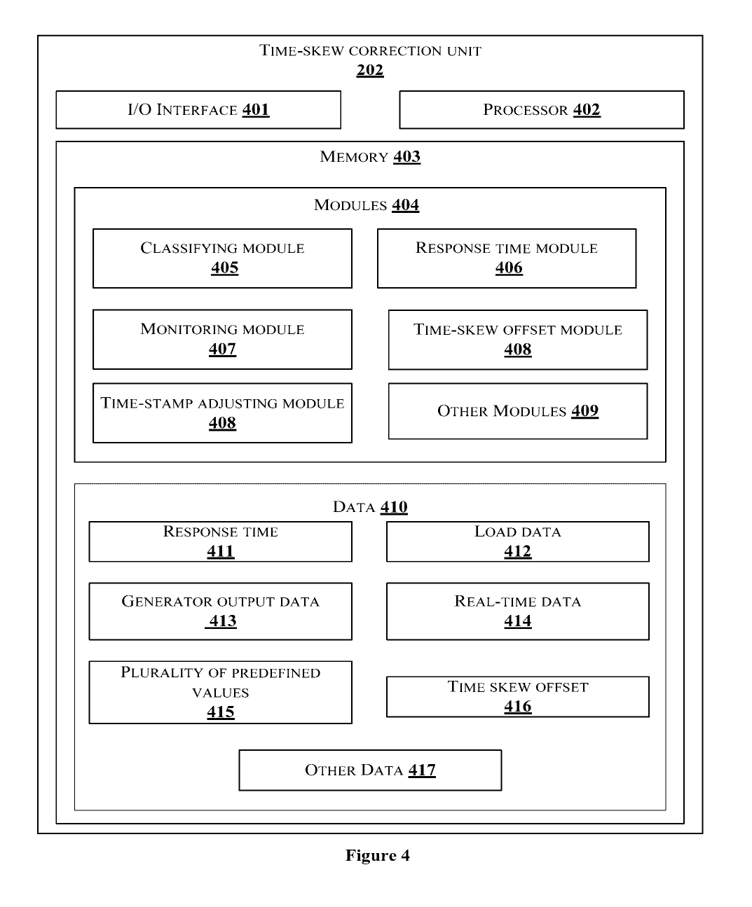

FIG. 4 illustrates a detailed block diagram of an exemplary time-skew correction unit with various data and modules for time-skew correction in an electric grid in accordance with some embodiments of the present disclosure.

The time-skew correction unit 202 comprises of an I/O interface 401, a processor 402 and a memory 403. In one implementation, the time-skew correction unit 202 may be implemented in a variety of computing systems, such as a laptop computer, a desktop computer, a Personal Computer (PC), a notebook, a smartphone, a tablet, e-book readers (e.g., Kindles and Nooks), a server, a network server, and the like.

In one embodiment, the time-skew correction unit along with the an I/O interface 401, the processor 402 and the memory 403 may be implemented as a method, system or article of manufacture using standard programming and/or engineering techniques to produce software, firmware, hardware, or any combination thereof. In another embodiment, mere processor 402 can be implemented in any suitable hardware, software, firmware, or combination thereof.

In one embodiment, the time-skew correction unit 202 receives the real-time data from plurality of regions 302 and response time 411 from the simulator 303 in the electric grid 301 through I/O interface 401. Also, output of the time-skew correction unit 202 i.e., the time-skew corrected data may be obtained from the I/O interface 401. In one embodiment, the result may be provided on a display unit (not shown in Figure). Further, the I/O interface 401 is coupled with the processor 402 of the time-skew correction unit 202 to obtain input and provide output.

The memory 403 in the time-skew correction unit 202 is communicatively coupled to the processor 402. The memory 403 stores processor executable instructions which on execution enable the time-skew correction unit 202 to perform time-skew correction on the real-time data in the electric grid 301. The processor 402 may comprise at least one data processor executing program components for executing user or system-generated requests for time-skew correction in the electric grid 301.

In the illustrated FIG. 4, the modules 404 and the data 410 stored in the memory 403 are described herein in detail.

In an embodiment, the data 410 in the memory 403 are processed by the one or more modules 404 of the time-skew correction unit 202. The modules 404 may be stored within the memory 403 as shown in FIG. 4. In an example, the one or more modules 404, communicatively coupled to the processor 402, may also be present outside the memory 403 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one embodiment, the data 410 may include, for example, response time 411, load data 412, generator output data 413, real-time data 414, plurality of predefined values 415, time skew offset 416 and other data 417.

The response time 411 is determined by the change in the generator output data 413 with respect to the change in the load data 412 during the simulation. Initially, the simulation is performed on modelled electric grid with the one or more generators and the one or more loads. The simulation involves changing the load data 412 from the one or more loads for plurality of predefined values 415 and computing the response time 411 by monitoring changes in corresponding output data 413 from the one or more generators.

The load data 412 is data at the one or more loads in the electric grid 301. In the present disclosure, the load data 412 is varied for the plurality of predefined values 415 to obtain the response time 411 used for determining the time-skew offset 416.

The generator output data 413 is output data from the one or more generators obtained when the load data 412 is varied for the plurality of predefined values 415 during simulation.

The real-time data 414 is data obtained from sensors associated with the plurality of regions 302 at real-time in the electric grid 301. The time-skew correction in accordance with the present disclosure is performed on the real-time data 414. For example, the real-time data may be one voltage data, current data, power data and other data associated with the electric grid 301 which would aid in time-skew correction.

The plurality of predefined values 415 are values by which the load data 412 is changed during simulation. In one embodiment, the plurality predefined values 415 may be greater than 100 Kilo watts of power. For each of the plurality of predefined values of change in the load data 412, corresponding generator output data 413 is obtained and thereby the response time 411 of the corresponding one or more generator is determined.

The time-skew offset 416 is determined by the time-skew correction unit 202 for each of the plurality of regions 302 based on the response time 411 and corresponding real-time data 411 obtained from the corresponding plurality of regions 302. In one embodiment, delay in the real-time data 414 is subtracted from the response time 411 of the corresponding one or more generators to obtain the time-skew offset 416. Further, the time-skew correction is performed for each of the plurality of regions 302 by adjusting the time-stamp of the real-time data 414 from the corresponding plurality of regions 302 based on the time-skew offset 416 of that plurality of regions 302.

The other data 419 may refer to such data which can be referred for time-skew correction in an electric grid 301.

In one implementation, the modules 404 may include, for example, classifying module 405, response time module 406, monitoring module 407, time-skew offset module 408, time stamp adjusting module 408 and other modules 409.

The classifying module 405 in the time-skew correction unit 202 classifies the electric grid 301 into plurality of regions 302. In one example, the classification is performed with respect to geographical region of the electric grid 301. Each of the plurality of regions 302 comprises of the one or more generators. In one embodiment, the classification is based on location of the control unit 200 in the electric grid 301. In an embodiment, there may be no generators in one or more of plurality of regions 302 and the time-skew correction is not performed for the said one or more plurality of regions.

The response time module 406 in the time-skew correction unit 202 obtains the response time 411 of the one or more generators. The one or more generators, for which the response time 411 is obtained, provide the output data 413 for the predefined value of change of the load data 412 during simulation. Further, the response time 411 is used for determining time-skew offset 416 of each of the plurality of regions 302 associated with the corresponding one or more generators.

The monitoring module 407 in the time-skew correction unit 202 monitors the plurality of regions 302 in real-time for a predefined value of change of load data from one or more loads in the electric grid 301.

The time-skew offset module 408 in the time-skew correction unit 202 determines the time-skew offset 416 for each of the plurality of regions 302. The time-skew offset 416 is based on the response time of the one of more generators and corresponding real-time data. In one embodiment, the time-skew offset is determined based on delay in the real-time data.

The time-stamp adjusting module 408 in the time-skew correction unit 408 adjusts the time-stamp of the real-time data 414 received from each of the plurality of regions 302. The adjusting of the time-stamp is based on the time-skew offset 416 of the corresponding plurality of regions 302.

The other modules 409 may refer to such modules which can be referred for time-skew correction in an electric grid 301.

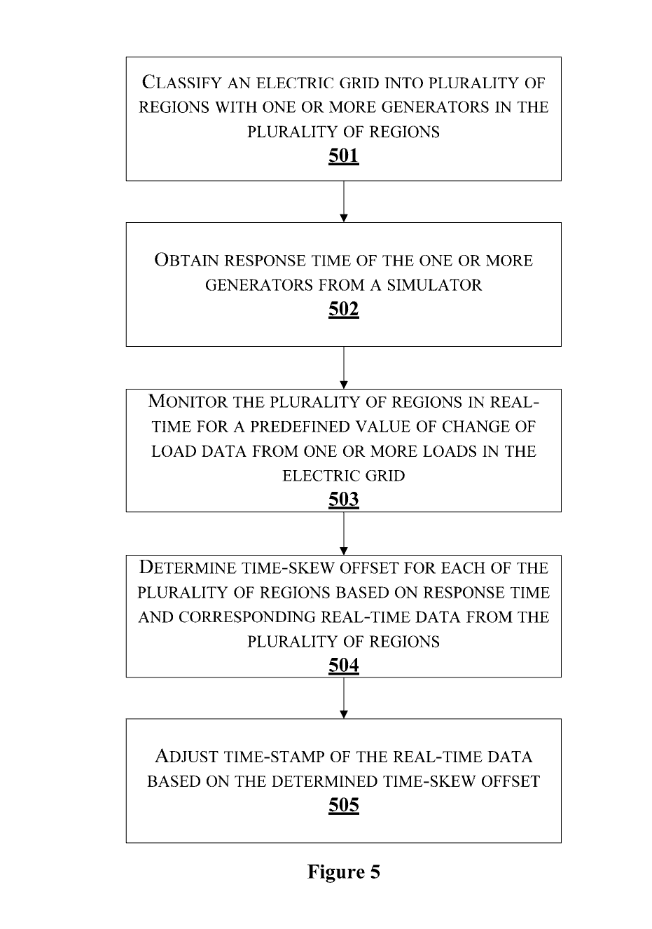

FIG. 5 illustrates a flow diagram showing steps performed by a time-skew correction unit in accordance with some embodiments of the present disclosure;

As illustrated in FIG. 5, the method comprises one or more blocks for time-skew correction in the electric grid 301. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 501, classify the electric grid 301 into plurality of regions 302. The classifying module 405 classifies the electric grid 301 into plurality of regions 302 with one or more generators in each of the plurality of regions 302.

At block 502, obtain the response time 411 of the one or more generators by the response time module 406. The response time 411 is obtained from the simulator 303. Initially, the simulation is performed on modelled electric grid with the one or more generators and the one or more loads. The simulation involves changing the load data 412 from the one or more loads for plurality of predefined values 415 and computing the response time 411 by monitoring changes in corresponding generator output data 413 from the one or more generators. The response time 411 is time taken for the change in the generator output data 413 with respect to the change in the load data 412 during the simulation. In one embodiment the change in the load above a predefined load is only consider.

At block 503, monitor the plurality of regions 302, by the monitoring module 407, in real-time for a predefined value of change of load data 412 from one or more loads. The predefined value is selected from the plurality of predefined values 415 where number of the one or more generators associated with the predefined value is greater than number of the one or more generators associated with other plurality of predefined values 415.

At block 504, determine the time-skew offset 416 for each of the plurality of regions 302 by time-skew offset module 408. The time-skew offset 416 is based on the response time 411 and the corresponding real-time data 414 form the plurality of regions 302.

At block 505, adjust time-stamp of the real-time data 414 by the time-stamp adjusting module 408 for time-skew correction in the electric grid 301. The adjusting of the time-stamp is based on the time-skew offset 416.

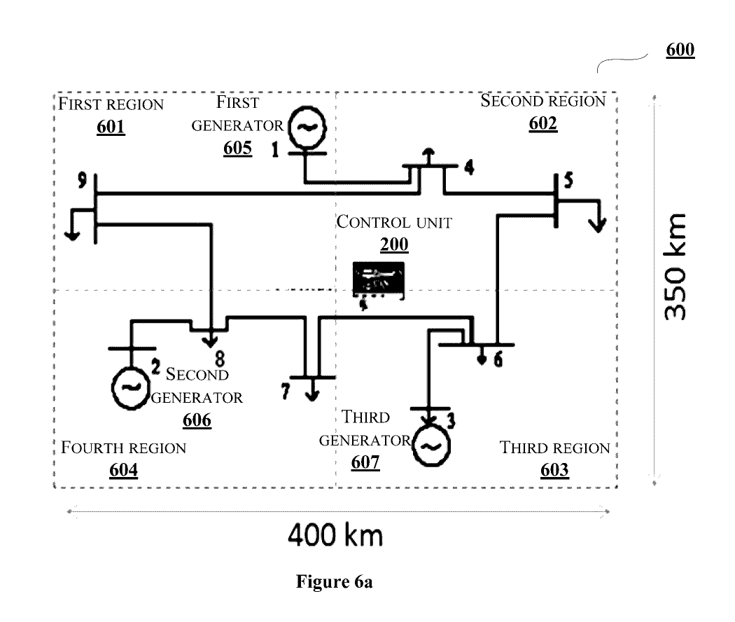

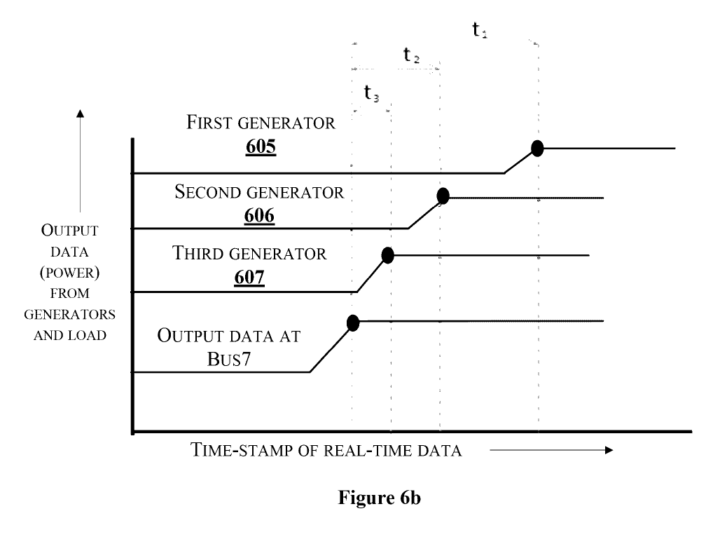

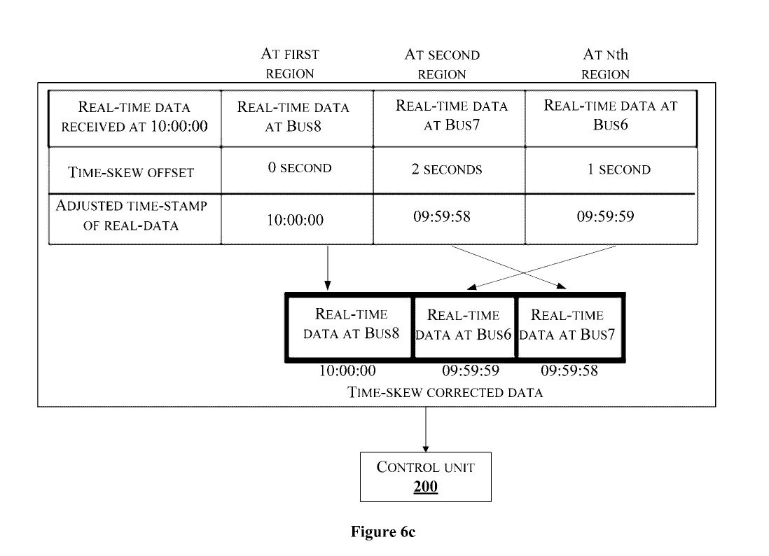

FIG. 6a illustrates an exemplary embodiment of an electric grid representing plurality of regions in accordance with some embodiments of the present disclosure.

In one exemplary embodiment, as illustrated in FIG. 6a the electric grid 600 of approximately 400 km×350 km of area, comprises of one or more generators (605, 606 and 607), one or more loads (4, 5, 6, 7, 8 and 9) and a control unit 200. The time-skew correction unit 202 (not shown in figure) is connected to the control unit 200 for performing time-skew correction in the electric grid 600. As described in the above description, the time-skew correction unit 202 classifies the electric grid 600 into plurality of regions namely first region 601, second region 602, third region 603 and fourth region 604. The first region 601 comprises first generator 605, the third region comprises the third generator 607 and the fourth region 604 comprises the second generator 606. The second region 602 does not comprise any generator. Upon the classification, simulation of the modelled electric grid is performed to obtain response time 411 of each of the one or more generators in the electric grid 600 which is described below.

Table 1 as shown below illustrates a table indicating dependency of output data of one or more generators on plurality of predefined values of change of load data in accordance with some embodiments of the present disclosure.

During simulation of the modelled electric grid 600, the load data 412 from the one or more loads is varied for plurality of predefined values 415 and the corresponding generator output data 413 is monitored.

TABLE 1

| | ΔL4 | ΔL5 | ΔL6 | ΔL7 | ΔL9 |
|---|---|---|---|---|---|
| ΔG1@R1 | True | True | False | True | True |
| ΔG2@R4 | False | True | True | True | True |
| ΔG3@R3 | True | True | True | False | False |

Table 1 indicates which generator provides output data 413 for a particular predefined value of change of load data 412. In Table 1, ΔG1, ΔG2 and ΔG3 indicate the output data 413 from the first generator 605, the second generator 606 and the third generator 607 respectively. R1, R3 and R4 indicate the first region 601, the third region 603 and the fourth region 604 respectively. Further, ΔL4, ΔL5, ΔL6, ΔL7 and ΔL9 indicate few of plurality of predefined values 415 of change in the load data at buses 4, 5, 6, 7 and 9 respectively. “TRUE” in the table indicates that the output data 413 is obtained from one of the generators for corresponding change in load data 412. i.e, there is a change in the output value of the generator due to the change in the load. “FALSE” in the table indicates that the output data 413 is not obtained. i.e. there is no change in the output value of the generator due to the change in the load. For example, consider ΔG1@R1 i.e., the first generator 605 at the first region 601 is providing output data for ΔL4, ΔL5, ΔL7 and ΔL9 at buses 4, 5, 6, 7 and 9 respectively. Therefore, ΔG1@R1 is indicated “TRUE” for ΔL4, ΔL5, ΔL7 and ΔL9 and “FALSE” for ΔL6 since no output data is obtained for ΔL6.

Table 2 as shown below illustrates an exemplary table indicating response time of each of the one or more generators with respect to change in the load data in a simulator in accordance with some embodiments of the present disclosure.

Upon obtaining the table indicating dependency of the generator output data 413 of one or more generators on plurality of predefined values of change of load data 412, response time 411 of the one or more generators are determined.

TABLE 2

| | ΔL4 | ΔL5 | ΔL6 | ΔL7 | ΔL9 |
|---|---|---|---|---|---|
| ΔG1@R1 | 1.5 sec | 1.5 sec | False | 1.5 sec | 1.5 sec |
| ΔG2@R4 | False | 1.5 sec | 1.5 sec | 1.5 sec | 1.5 sec |
| ΔG3@R3 | 1.5 sec | 1.5 sec | 1.5 sec | False | False |

In Table 2, ΔG1, ΔG2 and ΔG3 indicate the output data 413 from the first generator 605, the second generator 606 and the third generator 607 respectively. R1, R3 and R4 indicate the first region 601, the third region 603 and the fourth region 604 respectively. Further, ΔL4, ΔL5, ΔL6, ΔL7 and ΔL9 indicate few of plurality of predefined values 415 of change in the load data at buses 4, 5, 6, 7 and 9 respectively. In one embodiment, the response time 411 is determined for each of “TRUE” indication generators only. Further, a predefined value is selected from the plurality predefined values 415. The predefined value is selected in such a way that number of the one or more generators associated with the predefined value is greater than number of the one or more generators associated with other plurality of predefined values 415. In Table 2, the number of generators associated with predefined value of change in load data (ΔL5) is greater than the number of generators associated with other predefined values of change in load data (ΔL4, ΔL6, ΔL7 and ΔL9). Further, the electric grid 600 is monitored for load change with the predefined value and when there is a change of the predefined value in the load data, the time-skew offset 416 of each of the plurality of regions (601, 603 and 604) is determined. In one embodiment, the time-skew offset 416 of second region 602 is not determined since there is no generator associated with the second region 602 and further time-skew correction is not performed for the second region 602.

FIG. 6b illustrates a plot representing output data from one or more generators and associated one or more loads with respect to time-stamp of real-time data in accordance with some embodiments of the present disclosure.

In one embodiment, to determine the time-skew offset 416, the delay of the generator output data 413 is determined at real-time. As, illustrated in the plot in FIG. 6b, the first generator 605 provides real-time data 414 with a delay of t₁ the second generator 606 provides real-time data 414 with a delay of t₂, and the third generator 607 provides real-time data 414 with a delay of t₃ The delay is computed with respect to the real-time data 414 obtained from one of the loads.

In one embodiment, the time-skew offset 416 of the plurality of regions (601, 603 and 604) is obtained by subtracting the delay with the response time 411 of the corresponding one or more generators as given in equations 1, 2 and 3

Time-skew offset for the first region=t₁-response time of the first generator (1)

Time-skew offset for the third region=t₃-response time of the third generator (2)

Time-skew offset for the fourth region=t₂-response time of the second generator (3)

For example, consider the real-time data 414 from the first generator 605 is having the delay t₁ of 2 seconds and the response time 411 from Table 2 for the first generator 605 associated with the first region 601 is 1.5 seconds. The time skew offset of the first region as from equation 1 will be

Time-skew offset for the first region=2 seconds−1.5 seconds
Time-skew offset for the first region=0.5 seconds
Time-skew offset for the first region will be computed as 0.5 seconds.
FIG. 6c illustrates adjusting of time-stamp of real-time data in accordance with some embodiments of the present disclosure.

Upon determining time-skew offset 416 for each of the plurality of regions (601, 603 and 604), the time-skew correction unit 202 adjusts the time-stamp of the real-time data 414 received from each of the plurality of regions (601, 603 and 604) based on the time-skew offset 416 of the corresponding plurality of regions (601, 603 and 604).

The real-time data 414 is obtained at a particular time-stamp by the time-skew correction unit 202 and further, the time-skew correction unit 202 performs classification, obtains the response time 411 of the one or more generators and determines time-skew offset 416 for each of the plurality of region as illustrated previously. Upon determining the time-skew offset 416 for each of the plurality of regions, the time-stamp of the real-time data obtained from the sensors associated with each of the plurality of regions is adjusted based on the time-skew offset 416 of the corresponding plurality of regions.

For example, consider real-time data 414 is received at 10:00:00 time stamp from BUS8, BUS7 and BUS6, where BUS8 is associated with first region of an electric grid, BUS 7 is associated with second region of the electric grid and BUS6 is associated with Nth region of the electric grid. The time-skew correction unit 202 performs classification of the electric grid into N number of regions and obtains response time 411 from a simulator, for each of the N number of regions which are associated with at least one generator. Further time-skew offset 416 is determined for the said N number of regions in the electric grid. As illustrated in FIG. 6c, the time-skew offset 416 of the first region associated with BUS8 is 0 second, the time-skew offset 416 of the second region associated with BUS7 is 2 seconds and the time-skew offset 416 of the Nth region associated with BUS1 is 1 second. Based on the determined time-skew offset 416, the time-stamp of the real-time data 414 of the corresponding region is adjusted. Since the time-skew offset 416 of the N number of regions associated with BUS8 is 0 second, time-stamp adjusting is not performed on the real-time data 414 at BUS8. Further, the time-stamp of the real-time data 414 from BUS7 is adjusted to 9:59:58 from 10:00:00 since the time-skew offset 416 of the second region associated with BUS7 is 2 seconds and the time-stamp of the real-time data from BUS6 is adjusted to 9:59:59 from 10:00:00 since the time-skew offset 416 of the Nth region associated with BUS7 is 1 second. The time-skew corrected data is not detected as bad data and is provided to the control unit 200 for the state estimation of the electric grid.

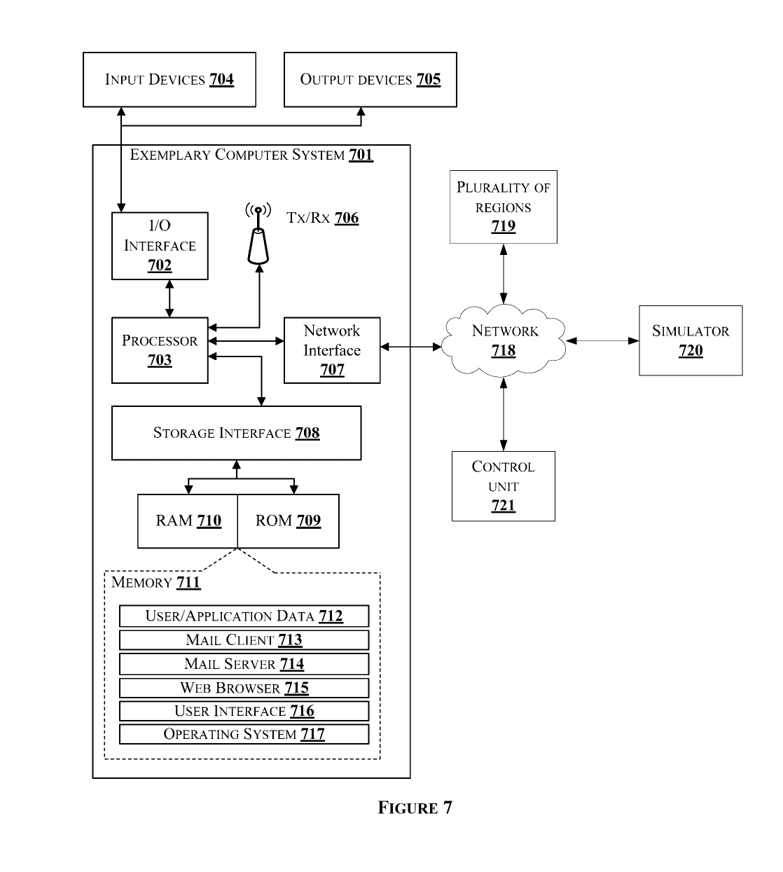

FIG. 7 illustrates a block diagram of an exemplary computer system for implementing some embodiments consistent with the present disclosure.

Variations of computer system 701 may be used for implementing all the computing systems that may be utilized to implement the features of the present disclosure. Computer system 701 may comprise a central processing unit (“CPU” or “processor”) 703. Processor 703 may comprise at least one data processor for executing program components for executing user- or system-generated requests. The processor may include specialized processing units such as integrated system (bus) controllers, memory management control units, floating point units, graphics processing units, digital signal processing units, etc. The processor 703 may include a microprocessor, such as AMD Athlon, Duron or Opteron, ARM's application, embedded or secure processors, IBM PowerPC, Intel's Core, Itanium, Xeon, Celeron or other line of processors, etc. The processor 703 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 703 may be disposed in communication with one or more input/output (I/O) devices via I/O interface 702. The I/O interface 702 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 702, the computer system 701 may communicate with one or more I/O devices. For example, the input device 704 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 705 may be a printer, fax machine, video display (e.g., cathode ray tube (CRT), liquid crystal display (LCD), light-emitting diode (LED), plasma, or the like), audio speaker, etc. In some embodiments, a transceiver 705 and 704 may be disposed in connection with the processor 703. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc. In one embodiment, the communication may be achieved by using one of Control Area Network (CAN) communication, Synchronous Peripheral Interface (SPI)/Serial Connect Interface (SCI) communication and Modbus communication.

In some embodiments, the processor 703 may be disposed in communication with a communication network 718 via a network interface 707. The network interface 707 may communicate with the communication network 718. The network interface 707 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 718 may include, without limitation, a direct interconnection, local area network (LAN), wide area network (WAN), wireless network (e.g., using Wireless Application Protocol), the Internet, etc. Using the network interface 707 and the communication network 718, the computer system 701 may communicate with plurality of regions 718, simulator 719 and control unit 720 which are associated with an electric grid. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 701 may itself embody one or more of these devices.

In some embodiments, the processor 703 may be disposed in communication with one or more memory devices (e.g., RAM 710, ROM 709, etc.) via a storage interface 708. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 711 may store a collection of program or database components, including, without limitation, an operating system 717, user interface application 716, web browser 715, mail server 714, mail client 713, user/application data 712 (e.g., any data variables or data records discussed in this disclosure), etc. The operating system 717 may facilitate resource management and operation of the computer system 701. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 716 may facilitate display, execution, interaction, manipulation, or operation of program components through textual or graphical facilities. For example, user interfaces may provide computer interaction interface elements on a display system operatively connected to the computer system 701, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 701 may implement a web browser 715 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 701 may implement a mail server 714 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 701 may implement a mail client 713 stored program component. The mail client may be a mail viewing application, such as Apple Mail, Microsoft Entourage, Microsoft Outlook, Mozilla Thunderbird, etc.

In some embodiments, computer system 701 may store user/application data 712, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

In one embodiment of the present disclosure, a time-skew correction unit is disclosed for time-skew correction in an electric grid by which time-skewed data will not be detected as bad data.

In one embodiment of the present disclosure, a time-skew correction unit is implemented in an electric grid with larger area and eliminates delay due to communication and distance between electrical components.

In one embodiment of the present disclosure, a time-skew correction unit is implemented in any electric grid comprising simulator and control unit for accurate state estimation.

In one embodiment of the present disclosure, a time-skew correction unit is reliable and cost efficient.

However a person skilled in art can envisage other application in medical field in which the current disclosure can be used. Further, the instant disclosure can be readily adopted in similar application with minor modification without departing from the scope of the present disclosure.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The terms “a”, “an” and “the” mean “one or more”, unless expressly specified otherwise.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The foregoing description of various embodiments of the disclosure has been presented for the purposes of illustration and description. It is not intended to be exhaustive or to limit the disclosure to the precise form disclosed. Many modifications and variations are possible in light of the above teaching. It is intended that the scope of the disclosure be limited not by this detailed description, but rather by the claims appended hereto. The above specification, examples and data provide a complete description of the manufacture and use of the composition of the disclosure. Since many embodiments of the disclosure can be made without departing from the spirit and scope of the disclosure, the disclosure resides in the claims hereinafter appended.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 101 | SCADA |
| 102 | Analyser |
| 103 | Topology processor |
| 104 | Bad data detector |
| 105 | State estimator |
| 200 | Control unit |
| 201 | SCADA |
| 202 | Time-skew correction unit |
| 203 | Analyser |
| 204 | Topology processor |
| 205 | Bad data detector |
| 206 | State estimator |
| 301 | Electric grid |
| 302 | Plurality of regions |
| 303 | Simulator |
| 401 | I/O interface |
| 402 | Processor |
| 403 | Memory |
| 404 | Modules |
| 405 | Classifying module |
| 406 | Response time module |
| 407 | Monitoring module |
| 408 | Time-skew offset module |
| 409 | Other modules |
| 410 | Data |
| 411 | Response time |
| 412 | Load data |
| 413 | Generator output data |
| 414 | Real-time data |
| 415 | Plurality of predefined values |
| 416 | Time-skew offset |
| 417 | Other data |
| 601 | First region |
| 602 | Second region |
| 603 | Third region |
| 604 | Fourth region |
| 605 | First generator |
| 606 | Second generator |
| 607 | Third generator |
| 701 | Computer system |
| 702 | I/O interface |
| 703 | Processor |
| 704 | Input devices |
| 705 | Output devices |
| 706 | Transceivers |
| 707 | Network interface |
| 708 | Storage interface |
| 709 | ROM |
| 710 | RAM |
| 711 | Memory |
| 712 | User/application data |
| 713 | Mail client |
| 714 | Mail server |
| 715 | Web browser |
| 716 | User interface |
| 717 | Operating system |
| 718 | Network |
| 719 | Plurality of regions |
| 720 | Simulator |
| 721 | Control unit |

We claim:

1. A time-skew correction unit in an electric grid, comprising:
a processor; and
a memory communicatively coupled to the processor, wherein the memory stores processor-executable instructions, which, on execution, causes the processor to:
classify the electric grid into a plurality of regions based on one or more generators in the said plurality of regions;
obtain response time of the one or more generators corresponding to each of the plurality of regions from a simulator;
monitor the plurality of regions in real-time for a predefined value of change of load data from one or more loads in the electric grid;
determine time-skew offset for each of the plurality of regions based on the response time of the one or more generator and corresponding real-time data from the plurality of regions, wherein the response time is associated with the predefined value of change of the load data; and
adjust time-stamp of the real-time data received from each of the plurality of regions, based on the time skew offset of corresponding plurality of regions for the time-skew correction in the electric grid.

2. The time-skew correction unit as claimed in claim 1, wherein the plurality of regions is selected with respect to a control unit associated with the electric grid.

3. The time-skew correction unit as claimed in claim 1, wherein obtaining the response time comprises performing simulation on modelled electric grid with the one or more generators and the one or more loads.

4. The time-skew correction unit as claimed in claim 3, wherein the simulation is performed for plurality of predefined values of change of load data of each of the one or more loads and corresponding change in output data from each of the one or more generators.

5. The time-skew correction unit as claimed in claim 4, wherein the load data and the output data are time-stamped at control unit.

6. The time-skew correction unit as claimed in claim 4, wherein the predefined value is selected from a plurality of predefined values.

7. The time-skew correction unit as claimed in claim 6, wherein the predefined value is associated with corresponding change in the output data of the one or more generators, wherein number of the one or more generators associated with the predefined value is greater than number of the one or more generators associated with other plurality of predefined values.

8. The time-skew correction unit as claimed in claim 1, wherein the response time is time taken for the change in the output data with respect to the change in the load data during simulation.

9. A method for time-skew correction in an electric grid, comprising:
classifying, by a time-skew correction unit, the electric grid into a plurality of regions with one or more generators in the said plurality of regions;
obtaining, by the time-skew correction unit, response time of the one or more generators corresponding to each of the plurality of regions from a simulator;
monitoring, by the time-skew correction unit, the plurality of regions in real-time for a predefined value of change of load data from one or more loads in the electric grid;
determining, by the time-skew correction unit, time-skew offset for each of the plurality of regions based on the response time of the one or more generator and corresponding real-time data from the plurality of regions, wherein the response time is associated with the predefined value of change of the load data; and
adjusting, by the time-skew correction unit, time-stamp of the real-time data received from each of the plurality of regions, based on the time skew offset of corresponding plurality of regions for the time-skew correction in the electric grid.

10. The method as claimed in claim 9, wherein obtaining the response time comprises performing simulation on modelled electric grid with the one or more generators and the one or more loads, wherein the simulation is performed for change of load data of each of the one or more loads and corresponding change in output data from each of the one or more generators.

11. The method as claimed in claim 9, wherein the predefined value is selected from a plurality of predefined values, and associated with corresponding change in the output data of the one or more generators, wherein number of the one or more generators associated with the predefined value is greater than number of the one or more generators associated with other plurality of predefined values.
